(19) United States
(12) Patent Application Publication
(10) Pub. No.: US 2026/0357788 A1
(43) Pub. Date: Nov. 12, 2026

(54) SYSTEMS AND METHODS FOR INSPECTING WIND TURBINES USING UNMANNED AUTONOMOUS TECHNOLOGY

(71) Applicant: General Electric Renovables Espana, S.L., Barcelona (ES)

(72) Inventors: Shaopeng Liu, Clifton Park, NY (US); Charles Burton Theurer, Alplaus, NY (US); YewTeck Tan, Niskayuna, NY (US); Douglas Roy Forman, Ballston Lake, NY (US); Alexandra Michaela Hof, Mannheim (DE); Honggang Wang, Clifton Park, NY (US); Mario Bachmann, Rheine (DE)

(21) Appl. No.: 19/134,423

(22) PCT Filed: Dec. 5, 2022
(86) PCT No.: PCT/US2022/051806

§ 371 Date: May 30, 2025

(51) Int. Cl. F03D 17/00; B63B 35/00; B63B 79/40; G05D 1/644; G05D 1/689; G05D 105/80; G05D 107/00; G05D 109/30

(52) U.S. Cl. CPC F03D 17/004; B63B 79/40; F03D 17/003; G05D 1/644; G05D 1/689; B63B 2035/007; G05D 2105/89; G05D 2107/25; G05D 2109/34

(57) ABSTRACT

A system for inspecting an offshore wind farm having one or more wind turbines includes an unmanned autonomous watercraft vessel. The unmanned autonomous watercraft vessel includes a positioning module for navigating the unmanned autonomous watercraft vessel to a wind turbine of interest in the offshore wind farm and positioning the unmanned autonomous watercraft vessel near the wind turbine of interest, an onboard data acquisition module comprising one or more sensors for collecting local data relating to health of the wind turbine of interest, and a controller comprising at least one processor. The processor(s) is configured to implement a plurality of operations, including, for example, receiving the local data from the one or more sensors and transporting the local data to a remote command center via a satellite communication link.

### STATEMENT REGARDING FEDERALLY SPONSORED RESEARCH OR DEVELOPMENT

This invention was made with U.S. government support under DE-EE0008390 awarded by the U.S. Department of Energy. The U.S. government has certain rights in the invention.

### RELATED APPLICATION

The present application claims priority to PCT Application No. PCT/US2022/051806, filed Dec. 5, 2022, which is incorporated by reference herein in its entirety.

### FIELD

The present subject matter relates generally to wind turbines and, more particularly, to systems and methods for inspecting wind turbines, such as offshore wind turbines, using unmanned autonomous technology.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

Certain wind turbines are arranged in a common geographical location and may be generally referred to as a wind farm. Wind farms can be located onshore or offshore. Particularly for offshore wind farms, it can be a challenge, both technically and economically, to complete inspection and maintenance, given their deployment environment (i.e., in the ocean). In addition, there can also be significant challenges in applying conventional inspection sensing technologies used for onshore wind turbines to offshore wind turbines due to the varying sea conditions.

Accordingly, the present disclosure is directed to systems and methods for providing improved inspection of wind farms, such as offshore wind farms, that address the aforementioned issues.

### BRIEF DESCRIPTION

Aspects and advantages of the invention will be set forth in part in the following description, or may be obvious from the description, or may be learned through practice of the invention.

In an aspect, the present disclosure is directed to a system for inspecting an offshore wind farm having one or more wind turbines includes an unmanned autonomous watercraft vessel. The unmanned autonomous watercraft vessel includes a positioning module for navigating the unmanned autonomous watercraft vessel to a wind turbine of interest in the offshore wind farm and positioning the unmanned autonomous watercraft vessel near the wind turbine of interest, an onboard data acquisition module comprising one or more sensors for collecting local data relating to health of the wind turbine of interest, and a controller comprising at least one processor. The processor(s) is configured to implement a plurality of operations, including, for example, receiving the local data from the one or more sensors and transporting the local data to a remote command center via a satellite communication link.

In another aspect, the present disclosure is directed to a method for inspecting an offshore wind farm having one or more wind turbines. The method includes navigating an unmanned autonomous watercraft vessel to a wind turbine of interest at the offshore wind farm via a positioning module of the unmanned autonomous watercraft vessel. The method also includes positioning, via the positioning module, the unmanned autonomous watercraft vessel near the wind turbine of interest. Further, the method includes collecting, via an onboard data acquisition module having one or more sensors, local data relating to health of the wind turbine of interest in the wind farm. In addition, the method includes transporting the local data to a remote command center via a satellite communication link.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective, interior view of one embodiment of a nacelle of a wind turbine according to the present disclosure;

FIGS. 3A and 3B illustrate schematic diagrams of an embodiment of a system for inspecting one or more wind turbines in a wind farm, such as an offshore wind farm, according to the present disclosure;

FIGS. 4A-4C illustrate schematic diagrams of an embodiment of various components of a system for inspecting one or more wind turbines in a wind farm, such as an offshore wind farm, according to the present disclosure;

FIG. 5 illustrates a schematic diagram of an embodiment of a system for inspecting one or more wind turbines in an offshore wind farm according to the present disclosure;

FIG. 6 illustrates a schematic diagram of another embodiment of a system for inspecting one or more wind turbines in an offshore wind farm according to the present disclosure;

FIG. 7 illustrates a schematic diagram of an embodiment of operating a system for inspecting one or more wind turbines in an offshore wind farm according to the present disclosure, particularly illustrating a system having two cameras;

FIG. 8 illustrates a schematic diagram of another embodiment of operating a system for inspecting one or more wind turbines in an offshore wind farm according to the present disclosure, particularly illustrating a system having two cameras;

FIG. 9 illustrates a schematic diagram of an embodiment of operating a system for inspecting one or more wind turbines in an offshore wind farm according to the present disclosure, particularly illustrating a system having one camera;

FIG. 10 illustrates a schematic diagram of an embodiment of a positioning module of a system for inspecting one or more wind turbines in an offshore wind farm according to the present disclosure;

FIG. 11 illustrates a schematic diagram of an embodiment of a dynamic positioning module of a positioning module of a system for inspecting one or more wind turbines in an offshore wind farm according to the present disclosure;

FIG. 12 illustrates a schematic diagram of an embodiment of a fault-tolerant positioning module of a positioning module of a system for inspecting one or more wind turbines in an offshore wind farm according to the present disclosure;

FIG. 13 illustrates a flow diagram of one embodiment of a method for inspecting one or more wind turbines in an offshore wind farm according to the present disclosure; and

FIG. 14 illustrates a block diagram of one embodiment of a controller of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to a system and method for inspecting one or more wind turbines in a wind farm, such as an offshore wind farm. For example, in an embodiment, the system may include an unmanned autonomous sea-going vessel equipped with a self-stabilizing data acquisition system having multiple sensors of various sensing modalities (e.g., visible range imaging, thermal imaging, LIDAR etc.). Further, the system includes a low-latency satellite communication link for remote control/command from a command center onshore when needed. As such, the vessel is capable of performing long-duration, region-wide inspections, and monitoring of fleets of offshore wind turbines. In addition, the onboard data acquisition system can perform data acquisition autonomously via a preplanned mission, or semi-autonomously via low latency triggering and tracking capabilities from a remote control center, such as an onshore control center. Further, the onboard data acquisition system can be self-stabilized to handle sea states and conditions. Moreover, in an embodiment, data analytics can be performed in real-time onshore, and more detailed inspection can be instructed as needed depending on the outcome of the analytics. For example, in an embodiment, the vessel can autonomously navigate to the wind turbine of interest for inspection (e.g., a safe distance in front of a wind turbine), and the data acquisition system can automatically point the imaging sensors/devices to the target (e.g., a section of a blade) to acquire an image/data. When needed, inspections can be performed via the communication link in a semi-autonomous fashion. For example, in an embodiment, an operator can issue a command to updated inspection targets, such as a new section of a blade or a new wind turbine, and the system can perform the updated mission autonomously. If anomalies/damages are detected by the system, a repair and/or maintenance order can be placed to avoid catastrophic failure of the wind turbine of interest.

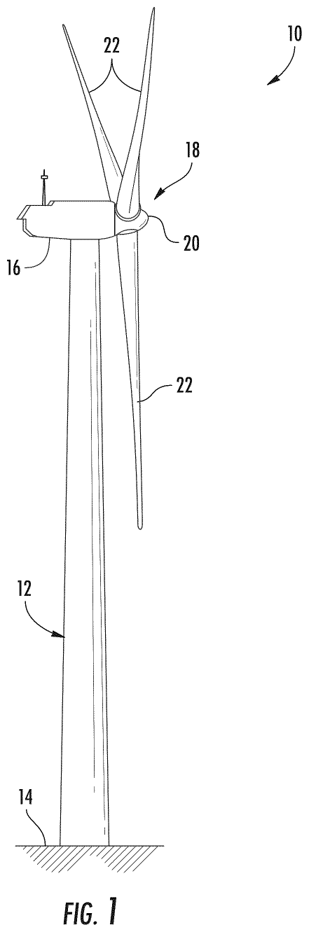

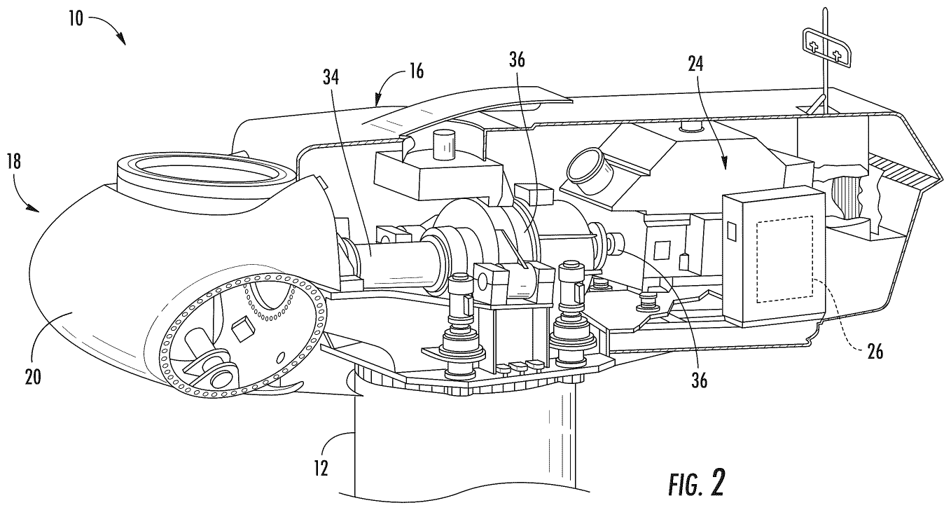

Referring now to the drawings, FIG. 1 illustrates perspective view of one embodiment of a wind turbine 10 according to the present disclosure. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally comprise as any suitable processing unit configured to perform the functions described herein. Thus, in several embodiments, the turbine controller 26 may include suitable computer-readable instructions that, when implemented, configure the controller 26 perform various different actions, such as transmitting and executing wind turbine control signals, receiving and analyzing sensor signals, and/or generating message signals. By transmitting and executing wind turbine control signals, the turbine controller 26 may generally be configured to control the various operating modes (e.g., start-up or shut-down sequences) and/or components of the wind turbine 10.

Referring now to FIG. 2, a simplified, internal view of one embodiment of the nacelle 16 of the wind turbine 10 is illustrated. As shown, the generator 24 may be disposed within the nacelle 16. In general, the generator 24 may be coupled to the rotor 18 of the wind turbine 10 for generating electrical power from the rotational energy generated by the rotor 18. For example, the rotor 18 may include a rotor shaft 34 coupled to the hub 20 for rotation therewith. The generator 24 may then be coupled to the rotor shaft 34 such that rotation of the rotor shaft 34 drives the generator 24. For instance, in the illustrated embodiment, the generator 24 includes a generator shaft 36 rotatably coupled to the rotor shaft 34 through a gearbox 38.

However, in other embodiments, it should be appreciated that the generator shaft 36 may be rotatably coupled directly to the rotor shaft 34. Alternatively, the generator 24 may be directly rotatably coupled to the rotor shaft 34 (often referred to as a “direct-drive wind turbine”).

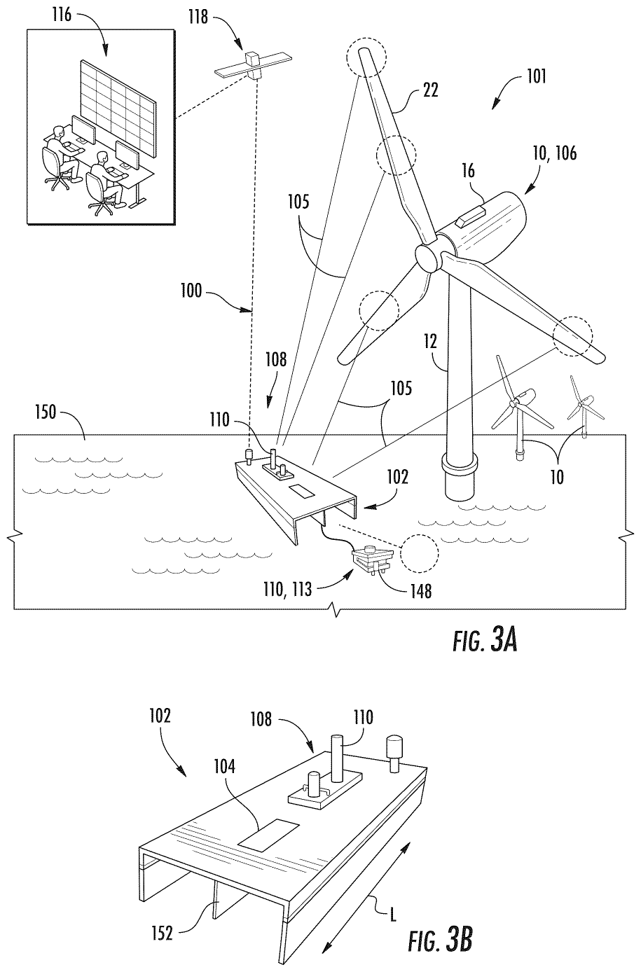

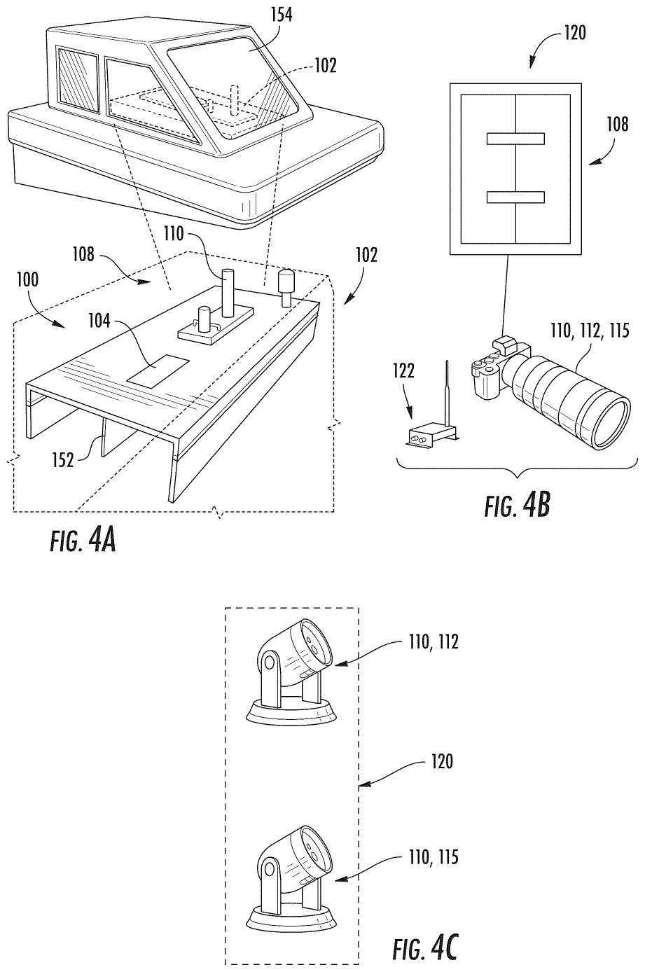

Referring now to FIGS. 3A-12, various views of components of a system 100 for inspecting an offshore wind farm 101 having one or more wind turbines according to the present disclosure is illustrated. In particular, as shown in FIGS. 3A, 3B, and 4A, the system 100 includes an unmanned autonomous watercraft vessel 102 configured to navigate offshore across a body of water 150 to the offshore wind farm 101. Thus, as shown in FIG. 3B, the unmanned autonomous watercraft vessel 102 may have any suitable length L and/or any other suitable features (such as one or more stabilizers 152) to provide a desired stability of the unmanned autonomous watercraft vessel 102 as the vessel 102 travels in sea conditions.

Moreover, as shown in FIGS. 3B and 4A, the system 100 includes a positioning module 104 for navigating the unmanned autonomous watercraft vessel 102 to a wind turbine of interest 106 in the offshore wind farm 101 and positioning the unmanned autonomous watercraft vessel 102 near the wind turbine of interest. In addition, as shown, the system 100 may include an onboard data acquisition module 108 having one or more sensors 110 (such as imaging devices) for collecting local data relating to health of the wind turbine of interest 106, and a controller 114. Such components are configured to communicate with each other and a remote command center 116 via a satellite communication link 118.

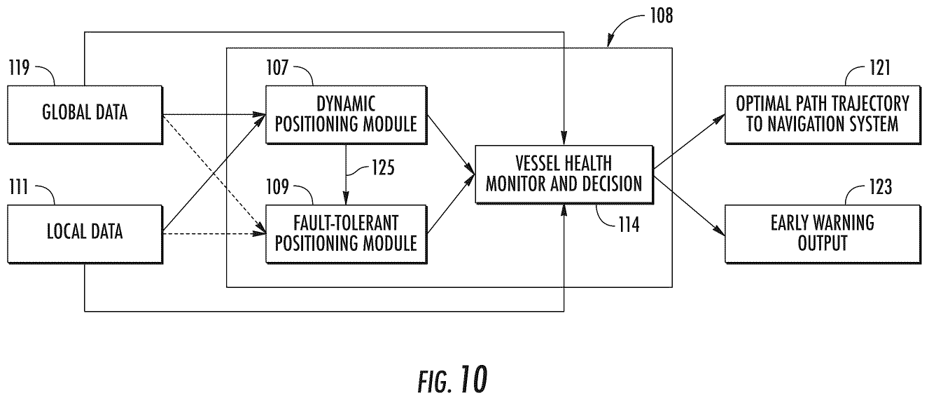

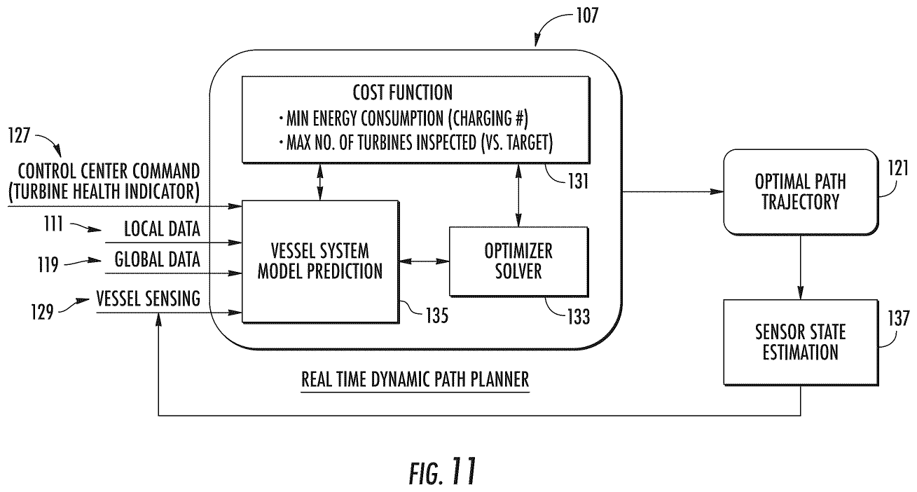

Referring particularly to FIG. 10, in certain embodiments, the positioning module 104 may include a dynamic positioning module 107 and a fault tolerant positioning module 109. For example, in such embodiments, the dynamic positioning module 107 is configured to send one or more planned paths to the fault tolerant module 109 (as indicated via arrow 125). Moreover, in an embodiment, as shown in FIGS. 10 and 11, the dynamic positioning module 107 is configured to receive local data 111 (such as wind speed, data from sea and vessel sensors, etc.) and global data 119 (such as weather forecast from a satellite communication link 118, etc.). In addition, as shown in FIG. 11, the dynamic positioning module 107 may also receive a control center command 127 and one or more vessel sensing data 129. Thus, the dynamic positioning module 107 may include a real-time dynamic path planner that is configured to generate, via a cost function 131, an optimizer 133, and/or a vessel system model prediction module 135, an optimal path trajectory 121 for the unmanned autonomous watercraft vessel 102 for a future time period and implement the optimal path trajectory 121 a step at a time.

In particular, as shown in FIG. 11, the vessel system model prediction module 135 receives various inputs, such as weather forecast, path map, vessel feedback information and provides the predicted result in a future time horizon (such as the next 1 hour, or the next 10 min, etc.). Further, as shown, the cost function 131 and the optimizer 133 generate the optimal path trajectory 121 within the future time horizon. However, in an embodiment, only the first few planned moves (or even only the first move) would be executed. Then, the system 100 re-executes the planning following the same pattern, which is also known as receding horizon path planning.

In such embodiments, this approach is configured to dynamically sense and respond to the change of the environment and vessel conditions. In an embodiment, for example, the control center command 127 may override any parameter (such as those in the cost function, vessel system model, etc.) or output (disable or add a bias) of the dynamic path planner.

In one example, the dynamic positioning module 107 may use a two-step vessel positioning approach to complete the turbine inspection navigation. In such embodiments, a first step is to use a coarse reference trajectory coded in the cost function 131 to navigate the unmanned autonomous watercraft vessel 102 close to the wind farm 101 (e.g., some distance from the unmanned autonomous watercraft vessel 102 to the wind turbine of interest 106, such as about 10 meters). As such, a second step is to use the refined tuning by adjusting the vessel position relevant to the wind turbine state (e.g., blade angle including yaw and pitch angle) when the unmanned autonomous watercraft vessel 102 is close enough to the wind turbine of interest 106 (e.g., some distance from the unmanned autonomous watercraft vessel 102 to the wind turbine of interest 106, such as less than about 10 meters). Accordingly, both steps may be implemented by adjusting any parameter (such as those in the cost function 131, the vessel system model prediction module 135, etc.) or output (disable or add a bias) of the dynamic path planner in real time.

Still referring to FIG. 11, in an embodiment, a unique aspect of the present disclosure is to use a turbine health indicator to affect the vessel path generation. For example, in an embodiment, blade leading edge erosion may be the health indicator, specifically surface roughness (%) of the blade leading edge. In such embodiments, the surface roughness (%) can be used to characterize the degree of the erosion. This information, from the remote command center 116, may become a priority constraint for the dynamic positioning optimization problem, which in turn affect the vessel inspection path. Moreover, as shown particularly in FIG. 11, the optimal path trajectory 121 can also be used by a sensor state estimator 137. For example, in an embodiment, the sensor state estimator 137 may use a Kalman Filter (or any other suitable filter) and the sensing inputs to the path planner (e.g., the local data 111, the global data 119, etc.) to estimate sensor states for a future time period once the optimal path trajectory 121 is generated. Moreover, as shown, the estimated sensor states can, in turn, be used with the real sensor states in a future time period to calculate an error, which can then be sent to the dynamic positioning module 107 for optimization.

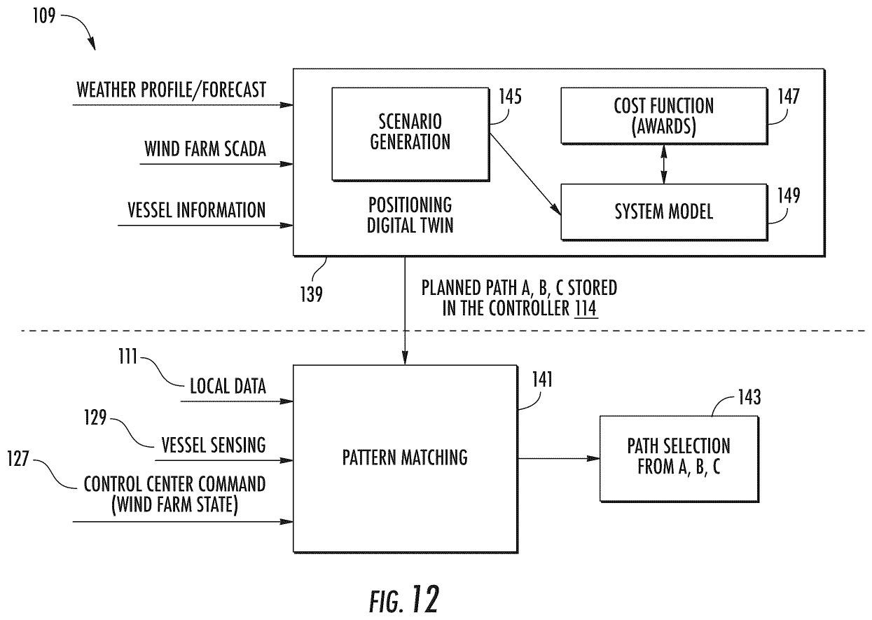

Referring now to FIG. 12, a schematic diagram of an embodiment of the fault tolerant positioning module 109 according to the present disclosure is illustrated. In particular, as shown, whenever one or multiple of below abnormal conditions occur, an edge controller at the unmanned autonomous watercraft vessel 102 may lose the key input signal to accomplish the real-time path planning. Therefore, a pre-stored planned path may be utilized with the information prior to the abnormal condition. Such action may occur when communication loss occurs with either of the remote command center 116 and/or the satellite communication link 118 and/or when partial failure of the unmanned autonomous watercraft vessel 102 or vessel sensor occurs.

In particular embodiments, for example, the fault tolerant positioning module 109 is configured to, at any time prior to the event (e.g., the abnormal condition), generate, via a positioning digital twin 139, the top three (or more) paths (e.g., A, B, and C) for the unmanned autonomous watercraft vessel 102 given the weather profile/forecast, wind farm SCADA data, vessel information, current conditions of the vessel 102 (e.g., location on the map, range, etc.), past historical dataset, etc. Moreover, as shown, the positioning digital twin 139 may include a scenario generation module 145, a cost function 147, and/or a system model 149. Thus, in an embodiment, based on the cost function 147 and the potential future scenarios 145, as well as the vessel system model prediction 149 (such as energy/material balance for the vessel system), the fault tolerant positioning module 109 can generate the top paths A, B, and C. In such embodiments, the top paths may be a pareto front or a result of a multi-objective optimization problem and may be associates with one or multiple corresponding abnormal conditions (such as partial failure of the input information).

After the event (e.g., the abnormal condition), partial information or functionality may be compromised. With the limited input information, the fault tolerant positioning module 109 may include a pattern matching module 141 for selecting the best path, as shown at 143, to navigate the system 100 according to the selected path. Once the system 100 recovers to normal, the system 100 may switch to utilizing the dynamic positioning module 107 again.

In addition, as shown in FIGS. 3A-5, the onboard data acquisition module 108 has one or more sensors 110 (such as imaging devices) for collecting local data 105 relating to the health of the wind turbine of interest 106. In particular embodiments, as shown in FIG. 4A, the onboard data acquisition module 108 may be enclosed in a waterproof vessel 154 for safely transporting the sensor(s) 110 out to sea. Moreover, in certain embodiments, the onboard data acquisition module 108 may be self-stabilizing, as will be further explained in more detail herein below. Moreover, in particular embodiments, for example, the sensor(s) 110 may include a plurality of sensors having a plurality of different sensor modalities. More specifically, in an embodiment, the plurality of sensor modalities may include visible range imaging, thermal imaging, or light detection and ranging (LIDAR) imaging. As such, the collected local data 105 may include data relating to a health state of the wind turbine of interest 106, an operational state of the wind turbine of interest 106, watercraft vessel sensing, and/or global information relating to the offshore wind farm 101 (such as weather forecast of the wind farm 101 from the satellite communication link 118 and/or environmental conditions near the wind turbine of interest 106). Moreover, the health state of the wind turbine of interest 106 may include a health indicator of the wind turbine of interest 106 (such as erosion, deflection, deformation, or defects), electrical component health (such as overheating, underheating, moisture content, or offline detection, etc.), and/or switching device health status.

In further embodiments, for example, the dynamic positioning module 107 is configured to set the health indicator as a priority constraint and affect an output of the optimal path trajectory 121 based on the health indicator. In particular embodiments, the dynamic positioning module 107 is also configured to generate a plurality of candidate paths for the unmanned autonomous watercraft vessel 102 based on different failure modes. In such embodiments, for example, the different failure modes may include a communication loss with the satellite communication link 118, a partial failure of the unmanned autonomous watercraft vessel 102, and/or the onboard data acquisition module 108. Further, the multiple candidate paths may be generated on an on-going basis and stored to the fault tolerant positioning module 109. In additional embodiments, the fault tolerant positioning module 109 is configured to select an optimal path from the stored multiple candidate paths based on an actual failure mode. Thus, as shown in FIG. 10, outputs of the dynamic positioning module 107 and the fault tolerant positioning module 109 are received by a vessel health monitor and decision module (also referred to herein as simply a controller 114) that outputs the optimal path trajectory path 121 and/or one or more warning indicators 123, such as early warning outputs.

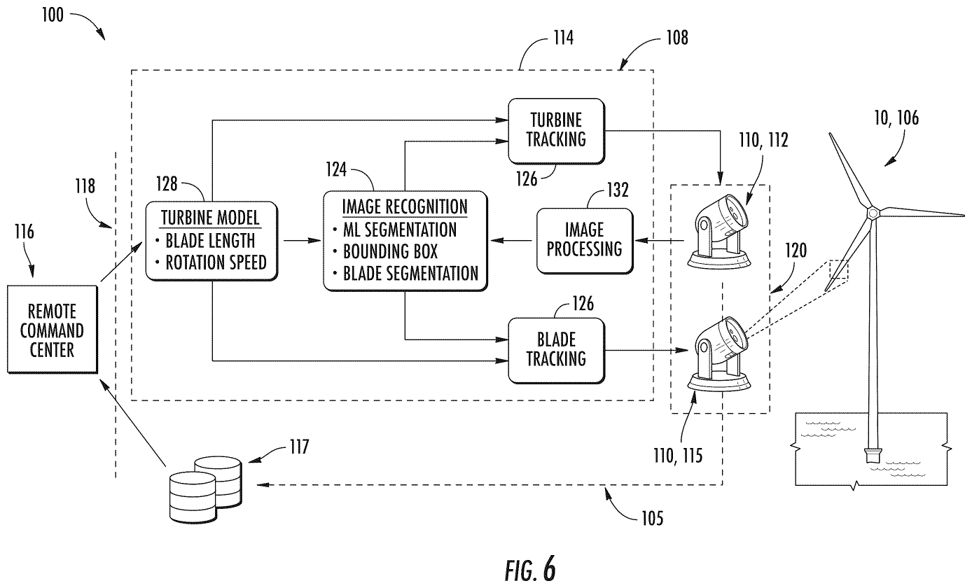

More particularly, in certain embodiments, the watercraft vessel sensing described herein may include one or more camera images of the wind turbine of interest 106. In such embodiments, as shown in FIGS. 4A-4C and 6, the camera image(s) may be captured by one or more self-stabilizing cameras 112, 115. For example, as shown, the system 100 may include a positioning camera 112 and a tracking camera 115 mounted or otherwise secured to a gimbal 120. In an embodiment, for example, the cameras 112, 115 may be secured atop of one or more platforms of the gimbal 120. As used here, a gimbal generally refers to a pivoted support that permits rotation of an object about an axis. Thus, in the present disclosure, the gimbal 120 allows the camera(s) 112, 115 to self-stabilize, even in non-stable conditions (such as the ocean or sea with constantly moving waves). In further embodiments, the system 100 may include any suitable stabilizing device, such as vertical stabilizers, horizontal stabilizers, vertical wind screens, horizontal wind screens, gyroscopes, tethers, and/or any other suitable devices for stabilizing the components of the system 100.

Moreover, as shown in FIG. 4B, the self-stabilizing cameras 112, 115 (and/or any of the sensors described herein) can be remote-controlled, e.g., via a remote trigger/control device 122. In such embodiments, for example, the remote trigger/control device 122 may be an antenna or receiver that can receive a signal from the remote command center 116. Such signals may use radio frequency signals, Wi-Fi signals, Bluetooth signals, or any other protocol for communication.

Thus, in an embodiment, as shown in FIG. 3A, the sensor(s) 110 may be configured to use burst photography for detecting defects, e.g., on a surface of the rotor blades 22, LIDAR for monitoring blade aero-elastic behavior, and/or infrared (IR)/thermal imaging for monitoring aerodynamic performance and/or for detecting defects in one or more surfaces of the wind turbine of interest 106 (such as a rotor blade surface). In addition, as shown in FIG. 3A, the sensor(s) 110 described herein may include one or more deploy able sensors 113 that can be launched from the unmanned autonomous watercraft vessel 102 for collecting the local data. Such deploy able sensor(s) 113, for example, may be secured to an underwater vessel 148 for collecting underwater data relating to the wind turbine of interest 106 (e.g., data related to a portion of the tower 12 or foundation (not shown) that is underwater). In further embodiments, the deploy able sensor(s) 113 may be secured to one or more unmanned aerial vehicles (UAVs) or drones for collecting the local data 105.

Moreover, in an embodiment, the onboard data acquisition module 108 may be configured to use artificial intelligence (AI) and/or one or more computer vision (CV)-based algorithms to target and track one or more moving components (e.g., the rotor blades 22) or non-moving components (e.g., the tower 12, etc.) of the wind turbine of interest 106 for data collection. Accordingly, in an embodiment, the wind turbine of interest 106 can remain in operation during inspection.

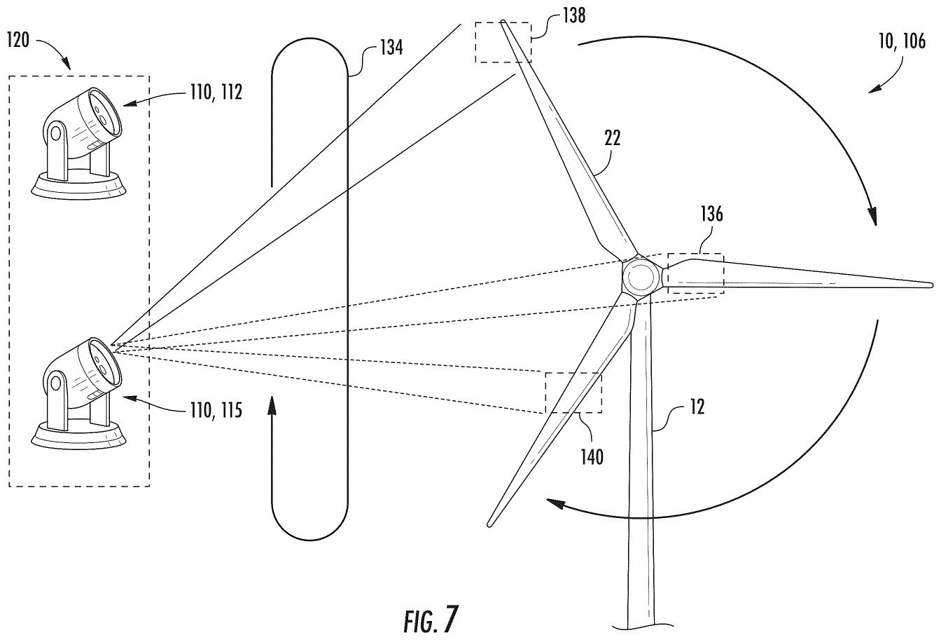

Referring particularly to FIGS. 7-9, various embodiments of operating the system 100 for inspecting an offshore wind farm 101 having one or more wind turbines according to the present disclosure are illustrated. In particular, as shown in FIG. 7, the system 100 may include two cameras, i.e., the positioning camera 112 and the tracking camera 115. In particular, the positioning camera 112 may be used to position the platform of the gimbal 120. Thus, in an embodiment, the positioning camera 112 may be a low resolution, wide angle, spotting camera, whereas the tracking camera 115 may be high resolution with zoom and tracking capability. As such, as shown, the tracking camera 115 can track the rotor blades 22, e.g., from root 136 to tip 138 and in between 140 while the wind turbine of interest 106 is in operation (as indicated by spiral motion path 134) or stopped. In such embodiments, the system 100 may require visual servoing (also known as vision-based robot control).

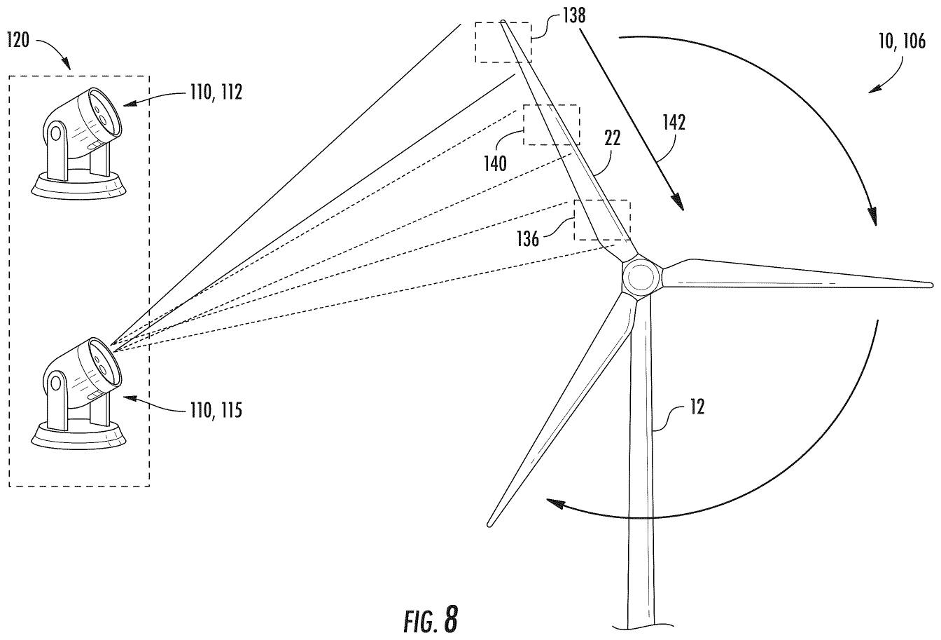

In another embodiment, as shown in FIG. 8, the system 100 may also include two cameras 112, 115, i.e., the positioning camera 112 and the tracking camera 115. In particular, the positioning camera 112 may be used to position the platform of the gimbal 120. Thus, in an embodiment, the positioning camera 112 may be a low resolution, wide angle, spotting camera, whereas the tracking camera 115 may be high resolution with zoom and tracking capability. Accordingly, as shown, the tracking camera 115 can track one of the rotor blade 22 to find the position of the root 136, the middle 140, and the tip 138 and perform burst photography in a straight or fixed points path motion as indicated via arrow 142. In such embodiments, the system 100 may not require visual servoing.

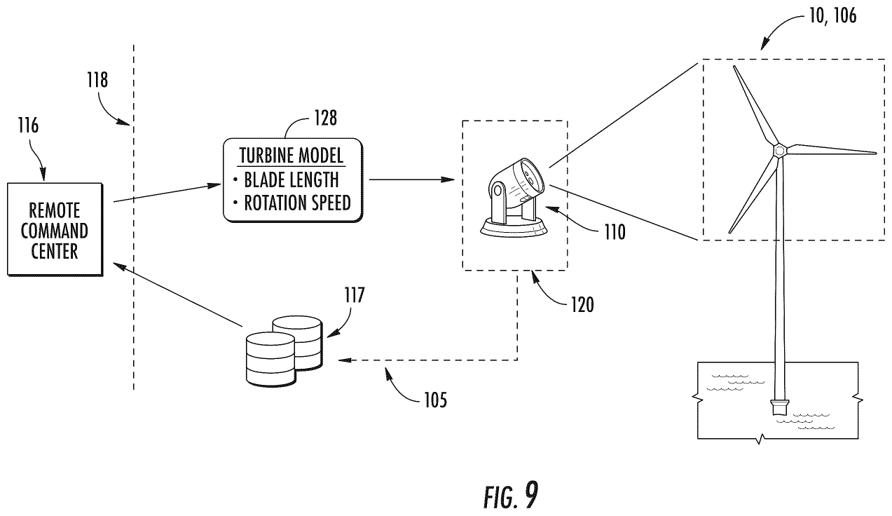

In still another embodiment, as shown in FIG. 9, the system 100 may include a single camera 110. Thus, in such embodiments, the camera 110 may be a high resolution, wide angle camera for tracking the entire wind turbine of interest 106, thereby eliminating the need for a tracking camera for finer targets. In such embodiments, the system 100 may have a fixed point (e.g., just one) motion path.

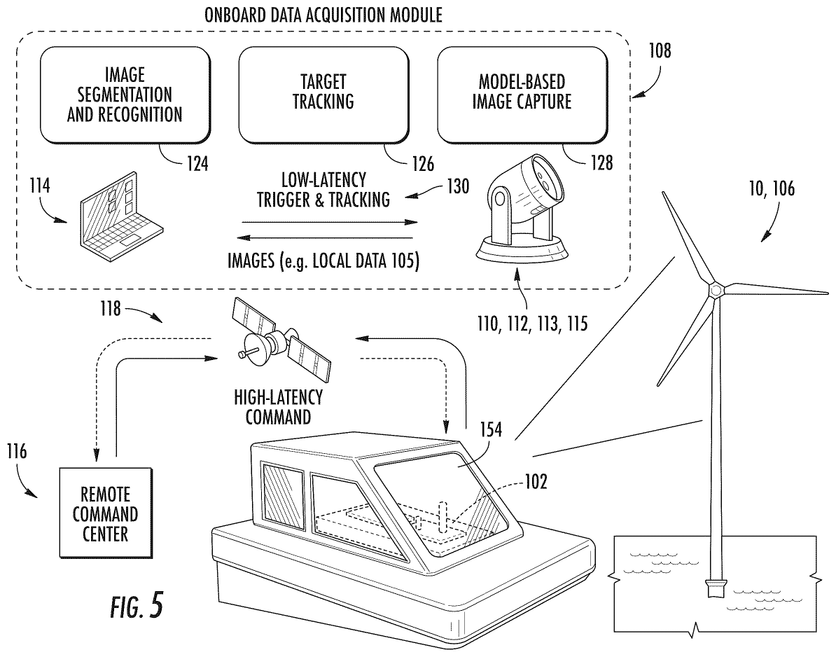

In addition, as shown in FIGS. 5 and 6, and as mentioned, the system 100 may also include the controller 114 having at least one processor and local storage 117 (FIG. 6). Thus, the controller 114 is configured to implement a plurality of operations. For example, in an embodiment, the plurality of operations may include receiving, by the controller 114, the local data 105 from the sensor(s) 110, e.g., via a network 130 and/or any processor. In an embodiment, for example, the network 130 may be a low-latency network. As used herein, a low-latency network generally refers to a computer network that is optimized to process a very high volume of data signals with minimal delay (latency). As such, low-latency networks are designed to support operations that require near real-time access to rapidly changing data.

In addition, as shown in FIGS. 5 and 6, the onboard data acquisition module 108 (and/or the controller 114) may be equipped with image segmentation and recognition capability 124, target tracking 126 (e.g., for the overall wind turbine and/or the rotor blades 22), and/or model-based image capture 128 for processing the local data 105. For example, in an embodiment, the image segmentation and recognition capability 124 may include machine learning (ML) segmentation, bounding box, and/or blade segmentation. Furthermore, as shown particularly in FIG. 6, the controller 114 may be equipped with image processing capability 132 to process collected data (e.g., images) before applying one or more of the features (e.g., tracking, image recognition, modeling, etc.) described herein.

Moreover, as shown in FIGS. 5 and 6, the controller 114 is configured to transport the local data 105 to a remote command center 116 via the satellite communication link 118 (FIGS. 3A and 5). More specifically, in an embodiment, the controller 114 may identify one or more anomalies or defects in the local data relating to the health of the wind turbine of interest and may transport the local data to the remote command center 116 along with the identified defect(s)/anomalies.

In particular embodiments, the remote command center 116 may be a remote control center onshore. Furthermore, in an embodiment, the controller 114 may be configured to send one or more warning indicators 123 (FIG. 10) of damage or wear relating to the wind turbine of interest 106. More specifically, in an embodiment, the warning indicator(s) may include a plurality of different levels or categories for classifying the damage and/or wear of the wind turbine of interest 106. For example, in an embodiment, the warning indicator(s) may include colors, such as green, yellow, or red. Therefore, in an embodiment, the warning indicator(s) may include self-health condition alerting (e.g., the vessel and the sensing system health level, 0-100, green/yellow/red, etc.), external condition alerting (e.g., extreme environments, high wave, strong wind, vessel tip over, not suitable for inspection, etc.), and/or wind turbine unexpected/server failure alerting (e.g., serve as a redundancy to turbine internal system).

Thus, in an embodiment, upon transporting the local data 105 to the remote command center 116 via the satellite communication link 118, if one or more anomalies are identified in the local data 105, the remote command center 116 can generate repair and/or maintenance orders and dispatch such orders to the wind farm 101.

In further embodiments, the system 100 may also receive one or more inspection commands for the wind turbine of interest 106 from the remote command center 116 via the satellite communication link 118. Thus, in such embodiments, the system 100 is configured to implement the inspection command(s). In such embodiments, for example and as mentioned, the unmanned autonomous watercraft vessel 102 may be equipped with an antenna or receiver that can receive a signal from the remote command center 116. Such signals may use radio frequency signals, Wi-Fi signals, Bluetooth signals, or any other protocol for communication.

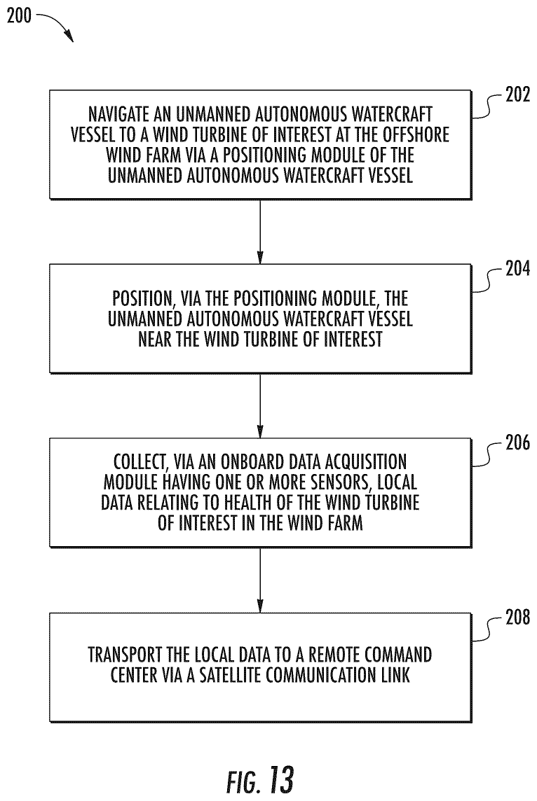

Referring now to FIG. 13, a flow diagram of an embodiment of a method 200 for inspecting an offshore wind farm having one or more wind turbines according to the present disclosure illustrated. In general, the method 200 is described herein as relating to offshore wind farms having one or more wind turbines, e.g., such as the wind farm illustrated in FIG. 3. However, it should be appreciated that the disclosed method 200 may be implemented using any other suitable wind farm both onshore and offshore. In addition, although FIG. 13 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes navigating an unmanned autonomous watercraft vessel to a wind turbine of interest at the offshore wind farm via a positioning module of the unmanned autonomous watercraft vessel. As shown at (204), the method 200 includes positioning, via the positioning module, the unmanned autonomous watercraft vessel near the wind turbine of interest. As shown at (206), the method 200 includes collecting, via an onboard data acquisition module having one or more sensors, local data relating to health of the wind turbine of interest in the wind farm. For example, in an embodiment, collecting the local data relating to health of the wind turbine of interest via the onboard data acquisition module may include using at least one of artificial intelligence (AI) or one or more computer vision (CV)-based algorithms to target and track one or more moving components of the wind turbine of interest for data collection. As shown at (208), the method 200 includes transporting the local data to a remote command center via a satellite communication link.

In additional embodiments, the method 200 may also include receiving, via a controller of the unmanned autonomous watercraft vessel, one or more inspection commands for the wind turbine of interest (e.g., such as new or updated commands) from the remote command center via the satellite communication link and implementing the one or more inspection commands via the system.

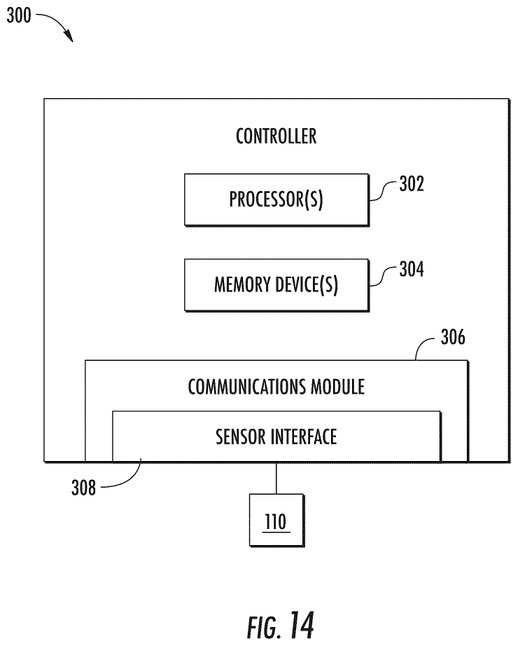

Referring now to FIG. 14, there is illustrated a block diagram of an embodiment of suitable components that may be included within a controller 300 (such as the turbine controller 26 or controller 114) according to the present disclosure. As shown, the controller 300 may include one or more processor(s) 302 and associated memory device(s) 304 configured to perform a variety of computer-implemented functions (e.g., performing the methods, steps, calculations and the like and storing relevant data as disclosed herein). Additionally, the controller 300 may also include a communications module 306 to facilitate communications between the controller 300 and the various components of the wind turbine 10. Further, the communications module 306 may include a sensor interface 308 (e.g., one or more analog-to-digital converters) to permit signals transmitted from the sensors (such as sensors 110) to be converted into signals that can be understood and processed by the processors 302. It should be appreciated that the sensors 110 may be communicatively coupled to the communications module 306 using any suitable means. For example, as shown, the sensors 110 are coupled to the sensor interface 308 via a wired connection. However, in other embodiments, the sensors 110 may be coupled to the sensor interface 308 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 304 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 304 may generally be configured to store suitable computer-readable instructions that, when implemented by the processor(s) 302, configure the controller 300 to perform various functions including, but not limited to, transmitting suitable control signals to implement control action(s) as described herein, as well as various other suitable computer-implemented functions.

Further aspects of the invention are provided by the subject matter of the following clauses:

A system for inspecting an offshore wind farm having one or more wind turbines, the system comprising: an unmanned autonomous watercraft vessel comprising: a positioning module for navigating the unmanned autonomous watercraft vessel to a wind turbine of interest in the offshore wind farm and positioning the unmanned autonomous watercraft vessel near the wind turbine of interest; an onboard data acquisition module comprising one or more sensors for collecting local data relating to health of the wind turbine of interest; and a controller comprising at least one processor, the at least one processor configured to implement a plurality of operations, the plurality of operations comprising: receiving the local data from the one or more sensors; and transporting the local data to a remote command center via a satellite communication link.

The system of any preceding clause, wherein the onboard data acquisition module is configured to use at least one of artificial intelligence (AI) or one or more computer vision (CV)-based algorithms to target and track one or more moving components of the wind turbine of interest for data collection.

The system of any preceding clause, wherein the one or more sensors comprise a plurality of sensors comprising a plurality of sensor modalities, the plurality of sensor modalities comprising at least one of visible range imaging, thermal imaging, or light detection and ranging (LIDAR) imaging.

The system of any preceding clause, wherein the local data comprises at least one of a health state of the wind turbine of interest, an operational state of the wind turbine of interest, watercraft vessel sensing, or global information relating to the wind farm, the method further comprising identifying one or more defects in the local data relating to the health of the wind turbine of interest and transporting the local data to the remote command center along with the identified one or more defects.

The system of any preceding clause, wherein the watercraft vessel sensing comprises at least one camera image of the wind turbine of interest, the camera image being captured by a self-stabilizing Gimbal camera.

The system of any preceding clause, wherein the global information comprises at least one of a weather forecast of the wind farm from the satellite communication link or environmental conditions near the wind turbine of interest.

The system of any preceding clause, wherein the health state of the wind turbine of interest comprises at least one of a health indicator of the wind turbine of interest, electrical component health, or switching device health status.

The system of any preceding clause, wherein the health indicator comprises at least one of erosion, deflection, deformation, or defects, and the electrical component health comprises at least one of overheating, underheating, moisture content, or offline detection.

The system of any preceding clause, wherein the onboard data acquisition module is self-stabilizing.

The system of any preceding clause, wherein the positioning module comprises a dynamic positioning module and fault tolerant positioning module, the dynamic positioning module configured to send one or more planned paths to the fault tolerant module.

The system of any preceding clause, wherein the dynamic positioning module is configured to: receive local and global information relating to the unmanned autonomous watercraft vessel; generate, via a cost function and an optimizer, an optimal path trajectory for the unmanned autonomous watercraft vessel for a future time period; and implement the optimal path trajectory a step at a time.

The system of any preceding clause, wherein the dynamic positioning module is configured to set the health indicator as a priority constraint and affect an output of the optimal path trajectory based on the health indicator.

The system of any preceding clause, wherein the dynamic positioning module is configured to generate a plurality of candidate paths for the unmanned autonomous watercraft vessel based on different failure modes, the different failure modes comprising at least one of a communication loss with the satellite communication link of the remote command center, a partial failure of the unmanned autonomous watercraft vessel or the onboard data acquisition module, the plurality of candidate paths being generated every on an on-going basis and stored to the fault tolerant positioning module.

The system of any preceding clause, wherein the fault tolerant positioning module is configured to select an optimal path from the plurality of candidate paths based on an actual failure mode.

The system of any preceding clause, wherein transporting the local data to the remote command center via the satellite communication link further comprises sending one or more warning indicators of damage relating to the wind turbine of interest.

The system of any preceding clause, wherein if, upon transporting the local data to the remote command center via the satellite communication link, one or more anomalies are identified in the local data, one or more repair or maintenance orders are generated by the remote command center.

The system of any preceding clause, wherein the plurality of operations further comprise receiving one or more inspection commands for the wind turbine of interest from the remote command center via the satellite communication link and implementing the one or more inspection command via the system.

A method for inspecting an offshore wind farm having one or more wind turbines, the method comprising: navigating an unmanned autonomous watercraft vessel to a wind turbine of interest at the offshore wind farm via a positioning module of the unmanned autonomous watercraft vessel; positioning, via the positioning module, the unmanned autonomous watercraft vessel near the wind turbine of interest; collecting, via an onboard data acquisition module having one or more sensors, local data relating to health of the wind turbine of interest in the wind farm; and transporting the local data to a remote command center via a satellite communication link.

The method of any preceding clause, further comprising: identifying, via a controller of the unmanned autonomous watercraft vessel, one or more defects in the local data relating to the health of the wind turbine of interest; and transporting the local data to the remote command center along with the identified one or more defects.

The method of any preceding clause, further comprising receiving, via a controller of the unmanned autonomous watercraft vessel, one or more inspection commands for the wind turbine of interest from the remote command center via the satellite communication link and implementing the one or more inspection commands.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for inspecting an offshore wind farm having one or more wind turbines, the system comprising:
an unmanned autonomous watercraft vessel comprising:
a positioning module for navigating the unmanned autonomous watercraft vessel to a wind turbine of interest in the offshore wind farm and positioning the unmanned autonomous watercraft vessel near the wind turbine of interest;
an onboard data acquisition module comprising one or more sensors for collecting local data relating to health of the wind turbine of interest; and
a controller comprising at least one processor, the at least one processor configured to implement a plurality of operations, the plurality of operations comprising:
receiving the local data from the one or more sensors; and
transporting the local data to a remote command center via a satellite communication link.

2. The system of claim 1, wherein the onboard data acquisition module is configured to use at least one of artificial intelligence (AI) or one or more computer vision (CV)-based algorithms to target and track one or more moving components of the wind turbine of interest for data collection.

3. The system of claim 1, wherein the one or more sensors comprise a plurality of sensors comprising a plurality of sensor modalities, the plurality of sensor modalities comprising at least one of visible range imaging, thermal imaging, or light detection and ranging (LIDAR) imaging.

4. The system of claim 1, wherein the local data comprises at least one of a health state of the wind turbine of interest, an operational state of the wind turbine of interest, watercraft vessel sensing, or global information relating to the wind farm, the method further comprising identifying one or more defects in the local data relating to the health of the wind turbine of interest and transporting the local data to the remote command center along with the identified one or more defects.

5. The system of claim 4, wherein the watercraft vessel sensing comprises at least one camera image of the wind turbine of interest, the camera image being captured by a self-stabilizing Gimbal camera.

6. The system of claim 4, wherein the global information comprises at least one of a weather forecast of the wind farm from the satellite communication link or environmental conditions near the wind turbine of interest.

7. The system of claim 4, wherein the health state of the wind turbine of interest comprises at least one of a health indicator of the wind turbine of interest, electrical component health, or switching device health status.

8. The system of claim 7, wherein the health indicator comprises at least one of erosion, deflection, deformation, or defects, and the electrical component health comprises at least one of overheating, underheating, moisture content, or offline detection.

9. The system of claim 1, wherein the onboard data acquisition module is self-stabilizing.

10. The system of claim 1, wherein the positioning module comprises a dynamic positioning module and fault tolerant positioning module, the dynamic positioning module configured to send one or more planned paths to the fault tolerant module.

11. The system of claim 10, wherein the dynamic positioning module is configured to:
receive local and global information relating to the unmanned autonomous watercraft vessel;
generate, via a cost function and an optimizer, an optimal path trajectory for the unmanned autonomous watercraft vessel for a future time period; and
implement the optimal path trajectory a step at a time.

12. The system of claim 11, wherein the dynamic positioning module is configured to set the health indicator as a priority constraint and affect an output of the optimal path trajectory based on the health indicator.

13. The system of claim 11, wherein the dynamic positioning module is configured to generate a plurality of candidate paths for the unmanned autonomous watercraft vessel based on different failure modes, the different failure modes comprising at least one of a communication loss with the satellite communication link of the remote command center, a partial failure of the unmanned autonomous watercraft vessel or the onboard data acquisition module, the plurality of candidate paths being generated every on an on-going basis and stored to the fault tolerant positioning module.

14. The system of claim 10, wherein the fault tolerant positioning module is configured to select an optimal path from the plurality of candidate paths based on an actual failure mode.

15. The system of claim 1, wherein transporting the local data to the remote command center via the satellite communication link further comprises sending one or more warning indicators of damage relating to the wind turbine of interest.

16. The system of claim 1, wherein if, upon transporting the local data to the remote command center via the satellite communication link, one or more anomalies are identified in the local data, one or more repair or maintenance orders are generated by the remote command center.

17. The system of claim 1, wherein the plurality of operations further comprise receiving one or more inspection commands for the wind turbine of interest from the remote command center via the satellite communication link and implementing the one or more inspection command via the system.

18. A method for inspecting an offshore wind farm having one or more wind turbines, the method comprising:
navigating an unmanned autonomous watercraft vessel to a wind turbine of interest at the offshore wind farm via a positioning module of the unmanned autonomous watercraft vessel;
positioning, via the positioning module, the unmanned autonomous watercraft vessel near the wind turbine of interest;
collecting, via an onboard data acquisition module having one or more sensors, local data relating to health of the wind turbine of interest in the wind farm; and
transporting the local data to a remote command center via a satellite communication link.

19. The method of claim 18, further comprising:
identifying, via a controller of the unmanned autonomous watercraft vessel, one or more defects in the local data relating to the health of the wind turbine of interest; and
transporting the local data to the remote command center along with the identified one or more defects.

20. The method of claim 18, further comprising receiving, via a controller of the unmanned autonomous watercraft vessel, one or more inspection commands for the wind turbine of interest from the remote command center via the satellite communication link and implementing the one or more inspection commands.
